(19) United States
(12) Patent Application Publication
(10) Pub. No.: US 2009/0055213 A1
(43) Pub. Date: Feb. 26, 2009

(54) Contents billing system, contents acquiring apparatus, contents acquiring method and program therefor and contents providing apparatus, contents providing method and program therefor

(75) Inventor: Satoshi Kawahata, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/229,014

(22) Filed: Aug. 19, 2008

(30) Foreign Application Priority Data
Aug. 23, 2007 (JP) P2007-217502

(51) Int. Cl. G06Q 30/00

(52) U.S. Cl. 705/1

(57) ABSTRACT

A contents billing system is disclosed. In the system, billing rate information for contents requested by a first user of a first terminal by calling is transmitted to the first terminal through a connection management server based on an instruction by a second user of a second terminal; the first terminal receives billing rate information and transmits agreement information according to an agreement operation on the billing rate by the first user to the second terminal through the connection management server; the connection management server notifies a billing server of the billing rate according to the agreement information and transmits the agreement information to the second terminal; the second terminal receives the agreement information, transmits recording permission information for the contents to the first terminal through the connection management server and transmits the contents to the first terminal; and the first terminal receives the recording permission information and acquires the selected contents from the second terminal.

### CROSS REFERENCES TO RELATED APPLICATIONS

The present invention contains subject matter related to Japanese Patent Application JP 2007-217502 filed in the Japanese Patent Office on Aug. 23, 2007, the entire contents of which being incorporated herein by reference.

### BACKGROUND OF THE INVENTION

1. Field of the Invention

The present invention relates to a contents billing system, a contents acquiring apparatus, a contents acquiring method and a program therefore and a contents providing apparatus, a contents providing method and a program therefor, and it particularly relates to a technology for billing contents to be exchanged under a P2P (or Peer-to-Peer) environment employing real time communication such as a telephone service.

2. Description of the Related Art

In recent years, “C-to-C (Consumer to Consumer” electric commerce has received attention in which general consumers directly have dealings by using an auction to be performed over a communication service such as the Internet, that is, so-called “net auction (which is also called “online auction”)”. In a net auction, setting a billing rate through payment may be performed between users. A system that bills according to video or music contents, for example, to be downloaded to a personal computer (PC), for example, such as a contents distribution service is also being widely acknowledged, and the number of subscribers to the services is explosively increased.

A user may concern about fees of such a contents distribution service over a communication service. For example, a billing method for a real time communication system that performs communication management such that a service user can estimate charges based on the billing rate defined by a service provider within a real time communication system is proposed in a commonly-owned earlier invention (refer to JP-A-2005-136627 (Patent Document 1)). According to the billing method, the possibility of receiving the bill of a larger sum of charges than the one that a service user expects can be advantageously eliminated.

### SUMMARY OF THE INVENTION

The technology proposed in Patent Document 1 has an advantage that the possibility of receiving the bill of a larger sum of charges than the one that a service user expects can be eliminated while it is difficult to dynamically and flexibly implement the definition of a billing rate, agreement and payment (banking) between users during communication in a real time communication system such as a telephone service. It is further difficult to record pay information (or contents) in connection with the definition of a billing rate and the agreement. Therefore, it is not highly convenient for a user who is difficult to easily acquire a billing rate from a network because of lack of experience for handling a terminal apparatus such as a PC.

Accordingly, it is desirable to improve the convenience of users in dealings of contents between users.

According to an embodiment of the present invention, there is provided a contents billing system that bills for contents provided between a first terminal and a second terminal establishing a session for calling and data communication through a connection management server, wherein billing rate information for contents requested to provide by a first user of the first terminal by calling is transmitted to the first terminal through the connection management server based on an instruction by a second user of the second terminal. The first terminal receives billing rate information on the selected contents and then transmits agreement information according to an agreement operation on the billing rate by the first user to the second terminal through the connection management server. Here, the connection management server notifies a billing server of the billing rate according to the agreement information and transmits the agreement information to the second terminal. The second terminal receives the agreement information on the billing rate information, then transmits provision permission information for the contents to the first terminal through the connection management server and transmits the contents to the first terminal. Then, the first terminal receives the provision permission information for the contents and then acquires the selected contents from the second terminal.

The configuration allows implementation of definition of a billing rate, provision of pay information and pay recording in real time during communication by using the first terminal and the second terminal between users, respectively.

According to an embodiment of the invention, the convenience of users can be improved in dealings of contents between users.

### BRIEF DESCRIPTION OF THE DRAWINGS

FIG. 1 is a network configuration diagram according to an embodiment of the invention;

FIG. 2 is a block diagram showing a configuration example of a user terminal (contents requesting side) according to an embodiment of the invention;

FIG. 3 is a block diagram showing a configuration example of a user terminal (contents providing side) according to an embodiment of the invention;

FIG. 4 is a sequence diagram for setting a billing rate and acquiring contents according to an embodiment of the invention;

FIG. 5 is a sequence diagram showing an example of the session establishment according to an embodiment of the invention;

FIG. 6 is an explanatory diagram of one example of an INVITE message according to an embodiment of the invention;

FIGS. 7A to 7C are explanatory diagram showing examples of billing rate instruction screens according to an embodiment of the invention;

FIG. 8 is an explanatory diagram for an example of a billing rate notification message according to an embodiment of the invention;

FIG. 9 is an explanatory diagram showing examples of a billing rate indication and an agreement screen according to an embodiment of the invention;

FIG. 10 is an explanatory diagram of an example of an agreement message according to an embodiment of the invention;

FIG. 11 is a configuration diagram showing an example of billing data for a user terminal according to an embodiment of the invention;

FIG. 12 is an explanatory diagram showing an example of an agreement indication screen according to an embodiment of the invention;

FIG. 13 is an explanatory diagram showing an example of a recording permission screen according to an embodiment of the invention;

FIG. 14 is an explanatory diagram for an example of a recording permission message according to an embodiment of the invention;

FIG. 15 is an explanatory diagram showing an example of the screen for notifying recording permission according to an embodiment of the invention; and

FIG. 16 is an explanatory diagram showing an example of a recording end screen according to an embodiment of the invention.

### DESCRIPTION OF THE PREFERRED EMBODIMENTS

With reference to attached drawings, an example of one embodiment of the invention will be described. This embodiment is an example in a case where a contents billing system according to an embodiment of the invention is applied to billing for dealings of contents between user terminals over an NGN (or Next Generation Network).

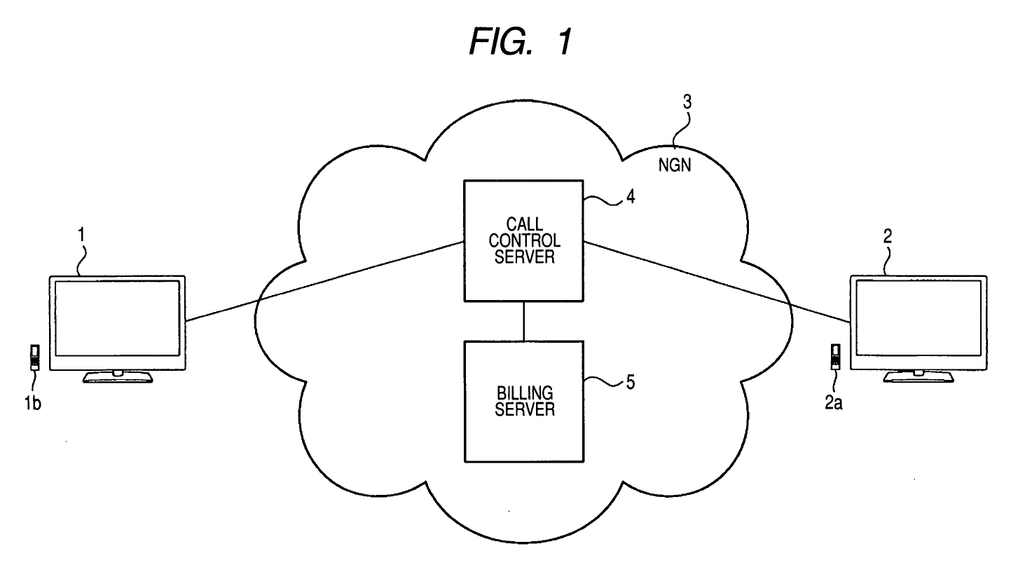

FIG. 1 is a configuration diagram of a network according to this embodiment. A user terminal 1 and a user terminal 2 shown in FIG. 1 connect to a call control server 4 (which is a connection management server) of an NGN 3. The call control server 4 connects to a billing server 5 that manages billing information for contents to be exchanged between user terminals. The establishment of sessions by the user terminals 1 and 2, call control server 4 and billing server 5 uses SIP.

The NGN 3 is a network allowing call control according to SIP (or Session Initiation Protocol). An NGN is a next generation IP network that integrates an IP network for internet services and a telephone network for telephone services, which are currently constructed separately, as an IP communication network with improved QOS (Quality of Service) and security by using an IP technology and may be an alternative for the current public network. The movement attempting to unitedly provide not only telephone services but also television broadcasting is making progress. Currently, the standardization of an NGN is under way mainly by ITU-T (International Telecommunications Union-Telecommunications Standardization Sector), and the movement focusing on the NGN construction by each of communication carriers has been activated even in Japan. A part of the communication carriers has already performed field trials.

The Y. 2001 Recommendations by ITU-T defines various characteristics to be provided to an NGN. One of important characteristics may be provision of guaranteed end-to-end QoS first of all. In an NGN, various access networks (such as xDSL, WiFi (Wireless Fidelity) and cellular phone terminals), terminals (such as telephones, PCs and information home appliances) and various applications are used. Under the environment, QoS is negotiated between a terminal and a network and is provided to a higher level application. The support for mobility comes next. The service availability is demanded even in communication with one mobile PC over various access networks such as xDSL at home, WiFi away from home and FTTH (Fiber TO The Home) at office or in communication from many PCs for movement within an office or for business trips. Y. 2001 Recommendations further defines the separation of the transfer function and the control function of a network, the support for various access networks, the convergence of a fixed network and a mobile network (FMC), emergency communication, adaptation to the restrictions against legal tapping, the detail description of which will be omitted herein.

The NGN standardization by ITU-T considers the connections with other standardization institutions important in the technological aspect. An IMS (IP Multimedia Subsystem), which is an important component of an NGN, was developed by 3GPP, which is a standardization organization for the third generation cellular phones, and SIP and most of other protocols used therein were developed by IETF (Internet Engineering Task Force).

The IMS adopted in the NGN standardization is a communication system that integrates public communication services having different circuit switches and packet switches in the past, such as a fixed telephone network and a mobile communication network, with SIP, which is a protocol for use by IP technologies and Internet telephones, to realize multimedia services.

The roles/functions of the IMS will be described briefly below. A first role/function is to support the establishment of a multimedia session. The technology for establishing end-to-end communication between multimedia terminals is multimedia session control. The IMS employs an IP transmission network as a bearer (transmission network) based on a protocol for session control, such as SIP, which is defined by IETF and provides a multimedia session within the IP transmission network or between the IP network and the other IP network, between other IMS networks or between PSTNs (fixed telephone network), for example.

A second role/function is a function (QoS control) in end-to-end communication that maintains certain transmission quality and guarantees and implements communication with a necessary transmission band secured. The IMS controls a network node on an IP packet transmission network according to the contract conditions and/or communication types (such as voice, video and data) of sending and receiving user terminals, selects a quality class, secures a necessary band and then establishes communication.

A third role/function is support for the interwork between an IP (packet) network and a circuit switched network. The IMS can not only provide an IP-based multimedia service to a cellular phone or a wireless LAN terminal, for example, independent of the access network but also provide a service by connecting to an existing telephone network or other IP packet transmission network.

The IMS further has roles/functions such as support for roaming, support for quick creation of an application service and new support for access from a network excluding a GPRS (General Packet Radio Service).

The protocol that can select a transmission band of a network excluding the IMS may be RSVP (Resource reSerVation Protocol), which is used for Diameter or QoS in an IP network in the past.

On the other hand, the SIP provides a function of identifying the other communication party and functions of calling/receiving/disconnection in order to establish a session. The SIP expresses a message, that is, communication data by text. A system employing SIP mainly includes a user agent and an SIP server. The user agent refers to a user terminal such as a PC having an IP telephone function. A user agent includes a user agent client having a function of transmitting a request and a user agent server having a function of responding to a request. According to this embodiment, the user terminal 1 corresponds to a user agent client, and the user terminal 2 corresponds to a user agent server.

The SIP server is the generic term for a proxy server, a redirect server, a registrar and a location server. Functions of the servers will be described briefly below.

The proxy server is a server that relays an SIP request from a user agent client to the next server. The proxy server provides functions of authentication, permission, network access control, routing, transfer of an SIP request and security.

The redirect server has a role of receiving a request and notifying a transmitting user agent of the current address of the receiving user agent. A user agent client transmits the request to the receiving address, which is returned from the redirect server. The redirect server does not transfer an SIP request, unlike the proxy server.

The registrar is a server that receives a request (REGISTER request) for registering the current position of a user agent client. The registrar generally operates on the same host computer as that of the proxy server and/or the redirect server.

The location server is a server that holds registration information from the registrar server and responds to a reference request for a received URI (Uniform Resource Identifier) by the redirect server or the proxy server. The location server may be placed in the same place as that of the SIP server.

It is not important that those servers (functions) are implemented on one host computer. It is also not important that they are placed in one same place. According to this embodiment, they are collectively represented by the call control server 4.

While a server that performs session (or connection) control according to SIP is called SIP server over an IP network, the IMS calls it as CSCF (Call Session Control Function). The CSCF is divided into three CSCFs of P-CSCF (Proxy-Call Session Control Function), I-CSCF (Interrogating Call Session Control Function) and S-CSCF (Serving-Call Session Control Function), which have different functions from each other.

Describing in more detail, the SIP has been reviewed as an important technology for integrating a telephone network to an IP network. Therefore, ENUM (E. 164 Number Mapping) is provided as an important function of the system of the SIP. The ENUM allows a general telephone number to be used by various IP network application including IP telephones.

The standardization of ENUM has been pursued by IETF and ITU-T in association. The connection between ENUM and SIP may include ENUM search by an SIP terminal (which is the user terminal 1 or 2 herein) and ENUM search by an SIP server (which is the call control server 4).

ENUM is a technology that relates a telephone number with an address or a service on a network and uses it as access means. A telephone number and a service or an address on a network are related by relating an internationally unique telephone number system (which is called “E164”), which is provided by ITU-T (International Telecommunications Union-Telecommunications Standards Section) with a special domain area (which is a sub-domain of “.e164.arpa”) through DNS (Domain Name System). Multiple addresses may be related with one number. For example, by relating your telephone number with an electronic mail address, a FAX number and/or a URL of a Web site by ENUM, the telephone number can be used as a unified identification number of the access means to you. For example, the domain name in ENUM (E164 Number) relating with the telephone number “03-1234-5678” may be “8.7.6.5.4.3.2.1.3.1.8.e164.arpa.” resulting from the replacement of the beginning “0” with the national number 81 of Japan and the realignment in reverse order. The address corresponding to the DNS record may be held in the user terminal 1 or 2 or the call control server 4.

The functions of ENUM allow a user to use a general telephone number for using various IP network applications unconsciously in particular.

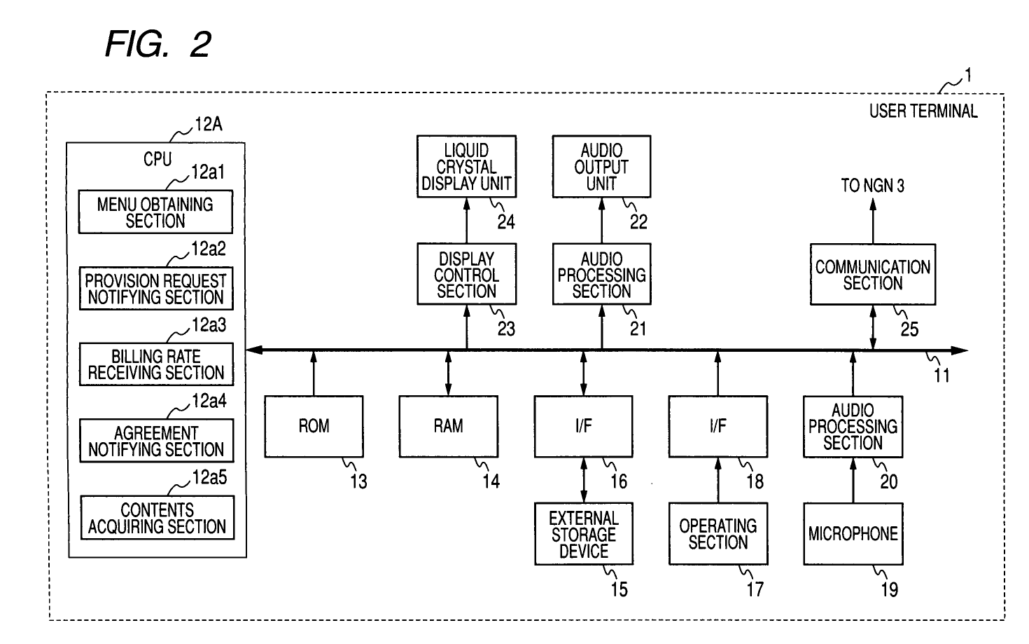

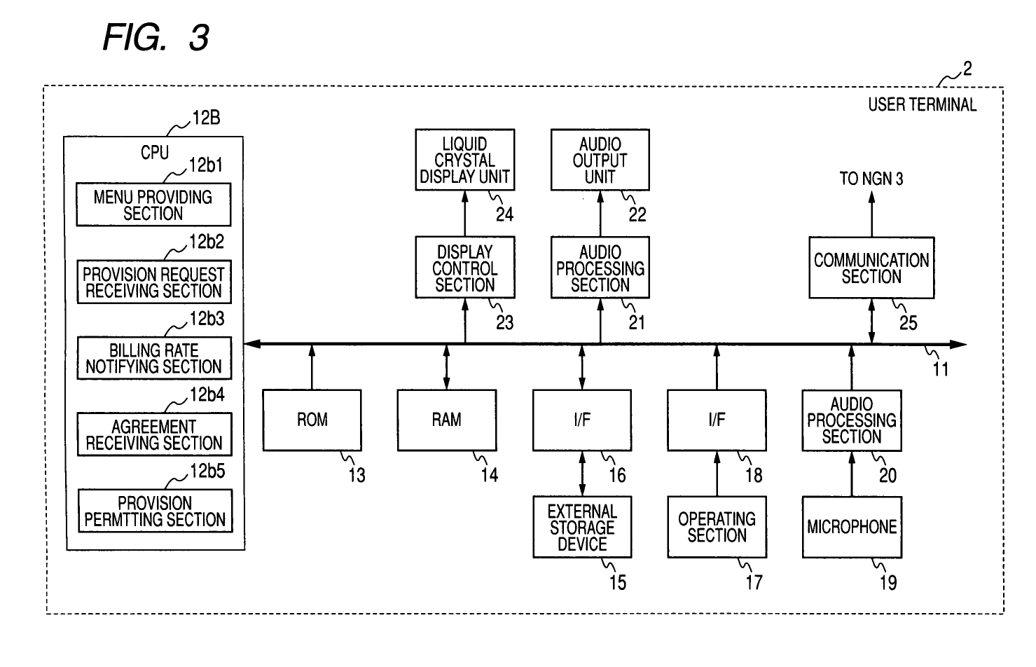

Next, the configurations of the user terminals 1 and 2 shown in FIG. 1 will be described. FIG. 2 is a block configuration example of the user terminal 1, and FIG. 3 shows a block configuration example of the user terminal 2. In FIG. 3, the same reference numerals are given to the parts corresponding to those in FIG. 2, and the detail descriptions will be omitted herein.

First of all, the user terminal 1 shown in FIG. 2 is a user agent client as described above and requests the user terminal 2 to provide contents according to a user's operation. The user terminal 1 may be an all-in-one terminal including a terminal specially for a TV (or television) telephone for NGN connection and a television receiver in a compact body. Without limiting thereto, a PC including a television telephone function or a NGN wireless communication terminal is applicable alternatively. The user terminal 1 includes a CPU 12A as a control section, and a ROM 13 and a RAM 14 connect to a bus 11 connecting to the CPU 12A. A program and/or data of computer software are written in the ROM 13. A program and/or data are expanded in the RAM 14.

The CPU 12A (control section) functions as a menu obtaining section 12a1, a provision request notifying section 12a2, a billing rate receiving section 12a3, an agreement notifying section 12a4 and a contents acquiring section 12a5 according to a program.

The menu obtaining section 12a1 is a function of obtaining contents menu information from the other terminal. The menu obtaining section 12a1 is used in a case where the distribution of contents is desired by accessing a contents distribution server operated by a provider, for example, but is not used in P2P communication between individual users as will be described later. The provision request notifying section 12a2 is a function of transmitting provision request information for the contents selected by a user to the other terminal. The billing rate receiving section 12a3 is a function of receiving billing rate information for the selected contents from the other terminal. The agreement notifying section 12a4 is a function of receiving an agreement operation on a billing rate by a user and transmitting the agreement information to the other terminal. Then, the contents acquiring section 12a5 is a function of receiving provision permission information for the contents from the other terminal having received agreement information therefor and acquiring contents selected from the other terminal.

An external storage device 15 connects to the bus 11 through an interface (I/F) 16. The external storage device 15 is a hard disk or semiconductor memory internally provided in the user terminal. Alternatively, the external storage device 15 may be a removable medium such as an optical disk recording medium and a memory card. The external storage device 15 may record audio, video or data contents, for example.

An operating unit 17 connects to the bus 11 through an interface 18. A microphone 19 and an audio output unit 22 further connect to the bus 11 through audio processing sections 20 and 21, respectively. A liquid crystal display unit 24 further connects to the bus 11 through a display control section 23.

The audio processing section 20 converts an analog audio signal from the microphone 19 to digital audio data and compresses it as necessary. The audio processing section 21 decompresses the digital audio data transmitted to the bus 11, if compressed, and converts it to an analog audio signal. The audio output section 22 may be a speaker or a head phone.

A communication unit 25 further connects to the bus 11 as an interface for connecting to an NGN 3 and exchanging contents. A remote controller apparatus 1 a is further provided, and a remote control signal is exchanged between the remote controller apparatus la and the user terminal 1 through a remote control signal receiving section, not shown, of the user terminal 1.

On the other hand, the user terminal 2 shown in FIG. 3 is a user agent server as described above and provides contents to the user terminal 1 according to the result of the negotiation with the user terminal 1. Like the user terminal 1, the user terminal 2 may be an all-in-one terminal including a TV (television) telephone dedicated terminal for NGN connection and a television receiver in a compact body. Without limited thereto, a PC including a television telephone function or NGN wireless communication terminal is applicable alternatively. The user terminal 2 includes a CPU 12B, and a ROM 13 and a RAM 14 connect to a bus 11 connecting to the CPU 12B. A program and/or data of computer software are written in the ROM 13. A program and/or data are expanded in the RAM 14.

The CPU 12B (control section) functions as a menu providing section 12b1, a provision request receiving section 12b2, a billing rate notifying section 12b3, an agreement receiving section 12b4 and a provision permitting section 12b5 according to a program.

The menu providing section 12b1 is a function of providing contents menu information to the other terminal during communication with the other party. The menu providing section 12b1 is used in a case where the distribution of contents is desired by accessing a contents distribution server operated by a provider, which notifies a contents menu to general user terminals, for example, but is not used in P2P communication between individual users as will be described later. The provision request receiving section 12b2 is a function of receiving provision request information for contents from the other terminal. The billing rate notifying section 12b3 is a function of transmitting billing rate information for the contents for which a provision request is received. The agreement receiving section 12b4 is a function of receiving an agreement information on billing rate information from the other terminal. Then, the provision permitting section 12b5 is a function of receiving agreement information and then transmitting provision permission information for the contents to the other party and transmitting the contents thereto.

A remote controller apparatus 2a is further provided, and the remote controller apparatus 2a and the user terminal 2 are configured to be capable of exchanging a remote control signal through a remote control signal receiving section, not shown, of the user terminal 2. Since the rest of the configuration of the user terminal 2 is the same as that of the user terminal 1, the description will be omitted herein.

Having described that the user terminal 1 and the user terminal 2 are a user agent client and a user agent server, respectively, for convenience of description, a television telephone or a PC including a television telephone function, for example, may generally has both of the functions, and the roles or positions are switched according to a user's operation.

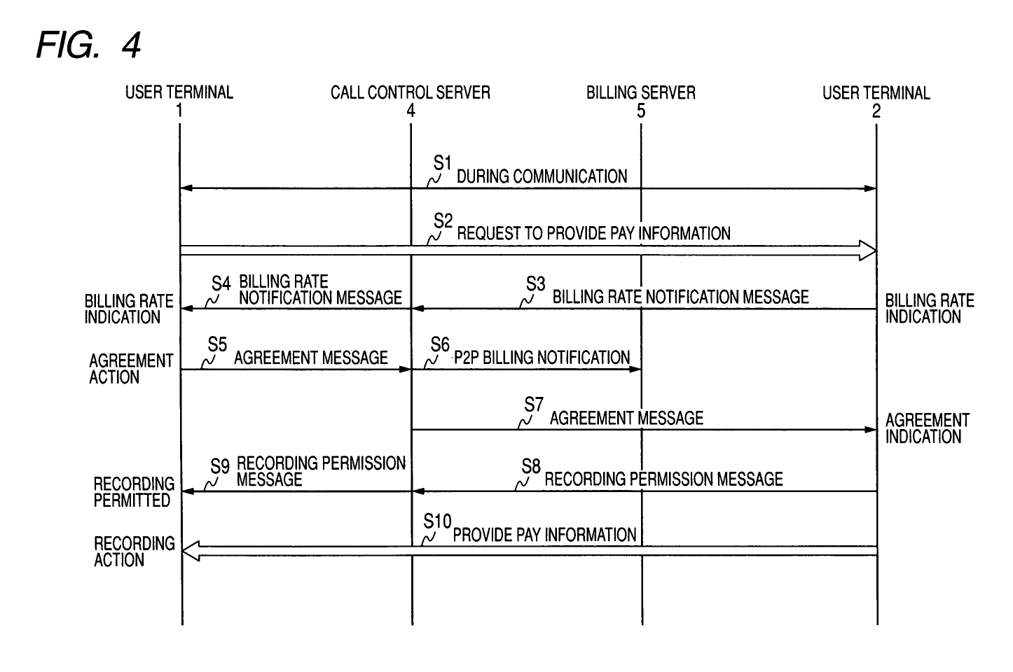

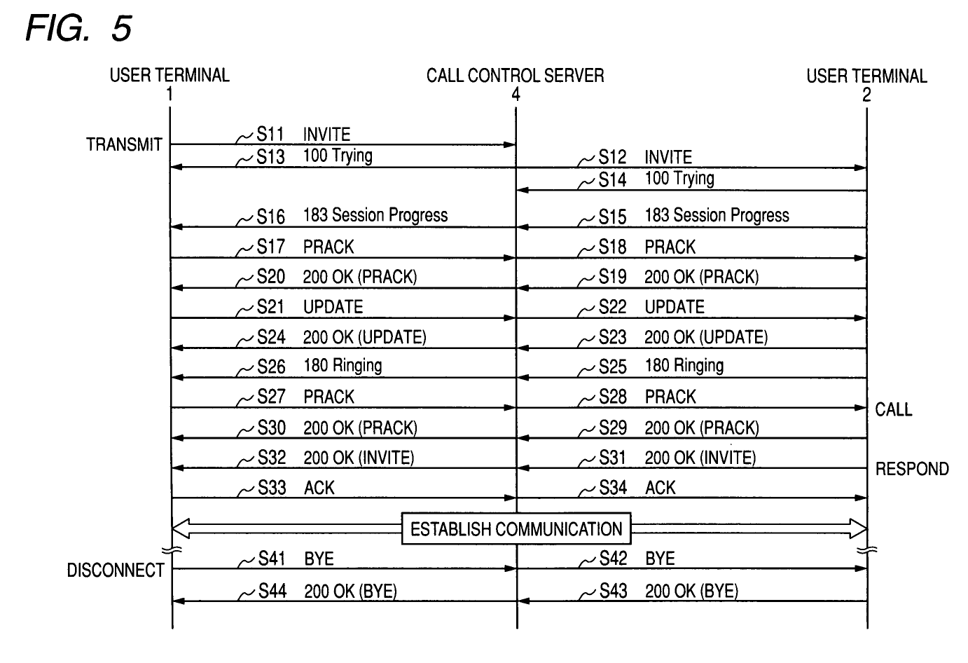

Next, the dynamic and flexible billing rate setting and contents acquisition between users according to this embodiment will be described. According to this embodiment, over an NGN network, a P2P billing method that allows dynamic and flexible setting of a billing rate, agreement and payment (banking) when pay information (such as contents) is traded between users (or user terminals) during communication. Contents can be recorded only if it is paid and approved. FIG. 4 is a sequence diagram for setting a billing rate and acquiring contents. FIG. 4 will be described with reference to FIGS. 5 to 11.

In the sequence in FIG. 4, the user terminal 1 and the user terminal 2 first establish communication (session) through the call control server 4 (step S1). The sequence of establishing a session in step S1 is shown in FIG. 5.

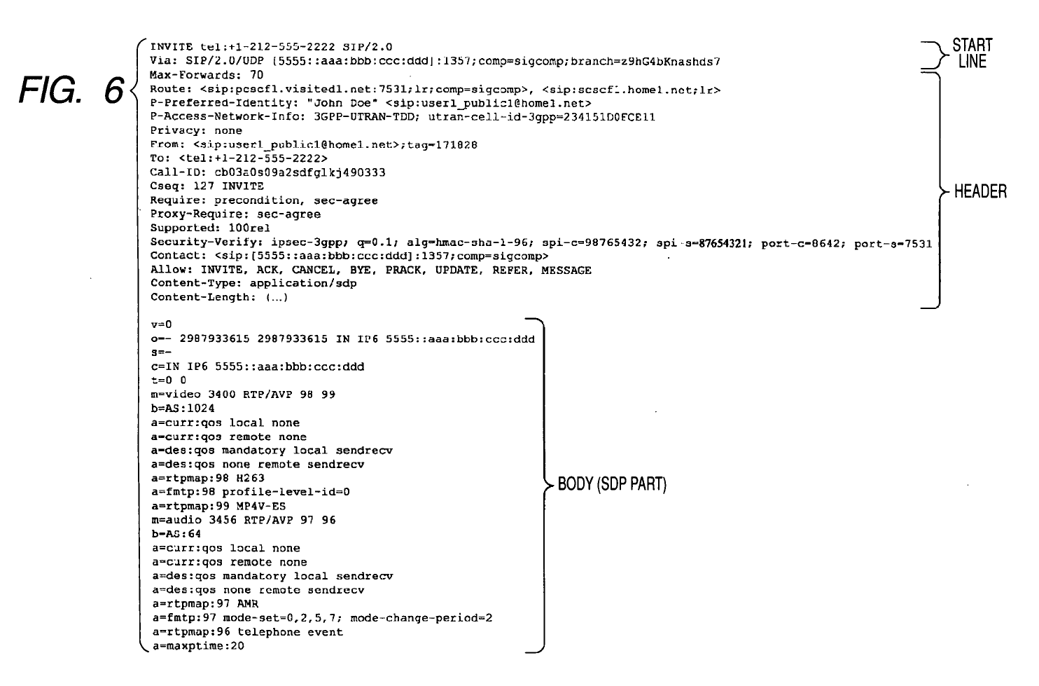

In the sequence of session establishment in FIG. 5, the CPU 12A of the user terminal 1 first in response to the receipt of a user's telephone operation transmits an “INVITE” request, which represents a connection request as shown in FIG. 6, to the call control server 4 (step S11).

SIP describes a message, that is, communication data by text as shown in FIG. 6. A massage according to SIP is roughly divided into a “start line”, a “header” and a “body”.

The start line is a first line of an SIP message and represents the purpose of the SIP message. A method name such as INVITE refers to what kind of control is requested by an SIP message, which is a request, and is defined by the specifications of RFC3261, 2976 or 3311, for example. The start line is called start line or request line according to a request from a user agent client or a response from a user agent server, respectively.

The header describes the details of control of an SIP message in detail and includes predefined meaningful multiple header lines.

The body is data to be transferred by an SIP message. In this example, information on a medium for establishing a session is expressed by a form of SDP (Session Description Protocol). Each record described by SDP has the details and form defined according to the type among a session description, time description and medium description.

For example, the line m describes a medium type, a port number, a transport protocol and a format. The line b describes band information. In the example shown in FIG. 6, the line m has “video”, and the line b has “AS:1024”, which state that the band to be used for video communication is 1024 kbps. The line m described therebelow has “audio”, and the line b has “AS:64”, which state that the band to be used for audio communication is 64 kbps.

Returning the description on the flowchart for session establishment in FIG. 5, the call control server 4 having received the “INVITE” request from the user terminal 1 transfers the “INVITE” request to the user terminal 2 (step S12) and transmits a response including a status code “100 Trying” meaning it is during trial to the user terminal 1 (step S13). The user terminal 2 having received the “INVITE” request returns a response including the status code “100 Trying” to the call control server 4 (step S14).

The user terminal 2 further returns a response including a status code “183 SessionProgress” referring to the progress and state of the session to the user terminal 1 through the call control server 4 (steps S15 and S16).

The user terminal 1 having received the response including the status code “183 Session Progress” from the user terminal 2 transmits a request “PRACK” meaning the acknowledgement of a provisional response to the user terminal 2 through the call control server 4 (steps S17 and S18).

The user terminal 2 having received the “PRACK” request from the user terminal 1 returns a response including a status code “200 OK (PRACK)” meaning the processing on the “PRACK” request has succeeded to the user terminal 1 through the call control server 4 (steps S19 and S20).

The user terminal 1 having received the response including the status code “200 OK (PRACK)” from the user terminal 2 transmits an “UPDATE” request meaning the change of the session to the user terminal 2 through the call control server 4 (steps S21 and S22).

The user terminal 2 having received the “UPDATE” request from the user terminal 1 returns a response including a status code “200 OK (UPDATE)” meaning that the processing for the “UPDATE” request has succeeded to the user terminal 1 through the call control server 4 (steps S23 and S24).

The user terminal 2 returns the response including the status code “200 OK (UPDATE)” and then transmits a response including a status code “180 Ringing” meaning prompting a user to answer the telephone (by ringing the call bell, for example) to the user terminal 1 through the call control server 4 (steps S25 and S26).

The user terminal 1 having received the response including the status code “200 OK (UPDATE)” from the user terminal 2 transmits a “PRACK” request meaning the acknowledgement of the provisional response to the user terminal 2 through the call control server 4 (steps S27 and S28).

The user terminal 2 having received the “PRACK” request from the user terminal 1 returns the response including the status code “200 OK (PRACK)” meaning that the processing for the “PRACK” request, that is, calling a user has succeeded to the user terminal 1 through the call control server 4 (steps S29 and S30).

The user terminal 2 returns the response including the status code “200 OK (PRACK)” and then returns a response including the status code “200 OK (INVITE)” meaning that the processing for the “INVITE” request in step S12 has succeeded, that is, a user has answered the phone to the user terminal 1 through the call control server 4 (steps S31 and S32).

On the other hand, the user terminal 1 having received the response including the status code “200 OK (INVITE)” transmits an “ACK” request indicating that the establishment of the session has been finally acknowledged to the user terminal 1 through the call control server 4 (steps S33 and S34). The series of steps in the processing establishes the session between the user terminal 1 and the user terminal 2, and the user terminal 1 and the user terminal 2 can perform real time communication. The sequences for establishing a session between the user terminal 1 and the user terminal 2 are only an example, and the invention is not limited thereto.

Since the sequence diagram in FIG. 5 illustrates processing of exiting (disconnecting) the session, it will be described briefly herein. In order to exit a session from the user terminal 1, a user may perform an operation for disconnecting communication on a Graphical User Interface (GUI), for example. Then, the user terminal 1 transmits a “BYE” request indicating the exit (disconnection) of the session to the user terminal 1 through the call control server 4 (steps S41 and S42).

The user terminal 2 having received the “BYE” request from the user terminal 1 returns the response including a status code “200 OK (BYE)” meaning that the processing for the “BYE” request has succeeded to the user terminal 1 through the call control server 4 (steps S43 and S44). Thus, the session ends.

Here, returning to the description of the sequences in FIG. 4, after the completion of the processing in step S1, a user of the user terminal 1 may request the provision of contents (pay information) saved in the user terminal 2 through real time communication with a user of the user terminal 2 (step S2). For example, a user may call and talk on a television telephone as an example of the real time communication and requests provision of contents if the contents is desired by the user. Alternatively, a user of the user terminal 1 may ask a user of the user terminal 2 to be permitted to view a part of contents saved in the user terminal 2. For example, a user of the user terminal 1 may view metadata on a video, a music, a computer program or data and the like, view a thumbnail of a video, or listen to an audition version of a music, which is recommended by a user of the user terminal 2. Then, a user of the user terminal 1 requests the provision of contents to a user of the user terminal 2 during conversation on a television telephone if the contents is desired by the user of the user terminal 1.

The pay information that a user can desire to provide is not limited to one prerecorded in recording medium of the other terminal, such as a video, a music, a computer program and data, but also includes a real time service such as words (or details) of fortune-telling by a fortune teller, for example.

The case that the pay information desired to provide is details of fortune-telling will be described below. During communication on a television telephone between a user of the user terminal 1 and a user of the user terminal 2, the user of the user terminal 1 may request “tell my fortune briefly” by voice to the user of the user terminal 2. The user of the user terminal 2 may answer “That will be 100-yen.”

At the same time, the user of the user terminal 2 having received the request to provide contents from the user of the user terminal 1 may operate the remote controller apparatus 2a or the user terminal 2 to display the billing rate for the target contents on the liquid crystal display unit 24. The user of the user terminal 2 may operate the remote controller apparatus 2a to enter the amount on the screen.

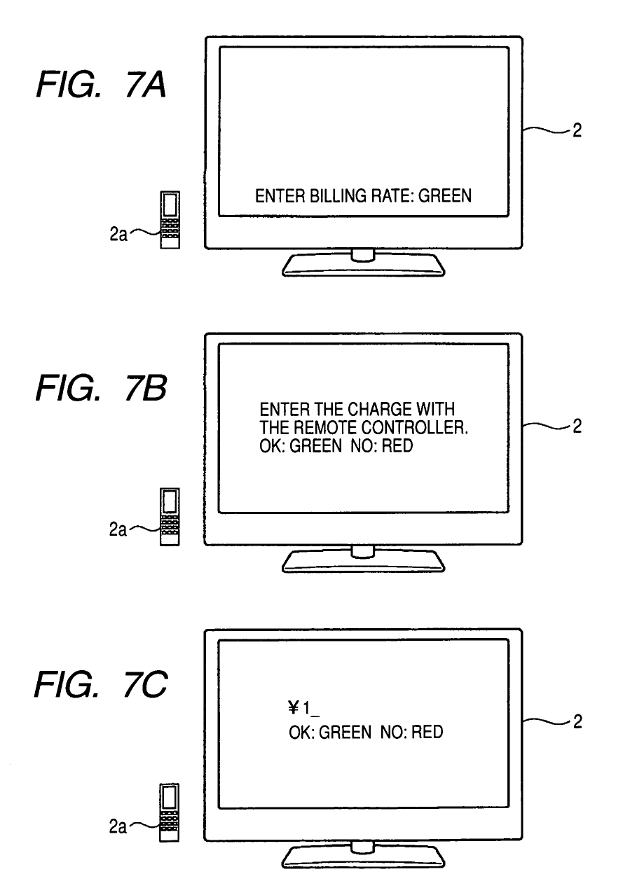

FIGS. 7A to 7C show an example of the billing rate instruction screen for information desired to provide. As shown in FIG. 7A, a message that requests the user 2 the instruction on whether an operation for entering a billing rate is to be performed or not is displayed on the user terminal 2. If the operation for entering a billing rate is to be performed, a “green” button, for example, on the remote controller apparatus 2a may be pushed. Next, as shown in FIG. 7B, a message that instructs to enter a billing rate (which may be a charged amount or price) for the information requested by the user is displayed on the user terminal 2. In order to enter a billing rate, the “green” button on the remote controller apparatus 2a may be pushed to move to the screen shown in FIG. 7C and then “1+0+0+OK (green)” are pushed.

If the entered billing rate is right, the user may click OK (green) button. The billing rate notifying section 12b3 of the user terminal 2 instructed the billing rate transmits a billing rate notification message to the call control server 4 (step S3).

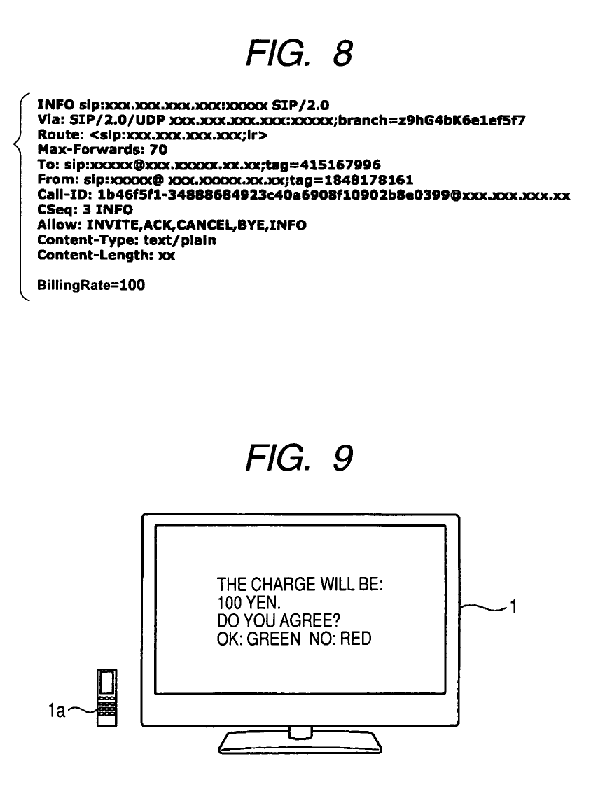

FIG. 8 shows an example of the billing rate notification message. The billing rate notification message describes an INFO method meaning the notification of information during a session at the start line of an SIP message. In the example shown in FIG. 8, “BillingRate=100” is described at the last billing rate line, which describes that the billing rate is 100 [yen].

Referring back to the sequence diagram in FIG. 4, the call control server 4 transmits the billing rate notification message to the user terminal 1 (step S4) if the billing rate transmitted by the user terminal 2 is stored to a main storage device. In the user terminal 1, the billing rate notification message transmitted by the call control server 4 is received by the billing rate receiving section 12a3, and the billing rate line described at the last line is read out and displayed on the liquid crystal display unit 24.

The agreement notifying section 12a4 of the user terminal 1 transmits the agreement message to the call control server 4 if the agreement on the displayed billing rate is instructed by the user (step S5).

FIG. 9 shows an example of the indication of the billing rate and the agreement screen. On the screen of the user terminal 1, the billing rate (100 yen) notified by the user terminal 2 is displayed. In addition, a message inquiring a user of whether the notified billing rate is to be agreed or not is displayed thereon. If the user of the user terminal 1 says “I agree” and push the OK (green) button on the remote controller apparatus 1a, the agreement message is transmitted to the user terminal 2. In order to disagree, the NO (red) button may be pushed.

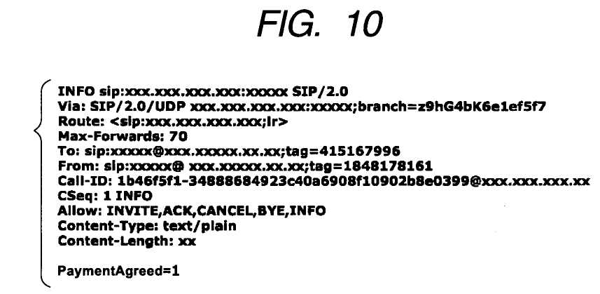

FIG. 10 shows an example of the agreement message. The agreement message describes an INFO method meaning the notification of information during a session at the start line of an SIP message. In the example shown in FIG. 10, “Payment Agreed=1” is described on the last agreement line. In the example, setting Flag 1 means the will of agreement.

Referring back to the sequence diagram in FIG. 4, if the call control server 4 receives the agreement message from the user terminal 1, the call control server 4 notifies the billing rate information stored in the main storage device to the billing server 5 (step S6) and transmits the agreement message to the user terminal 2 (step S7). The billing server 5 having received the billing rate information stores the billing rate information input by the call control server 4 to P2P billing information n of the billing data for the user terminal.

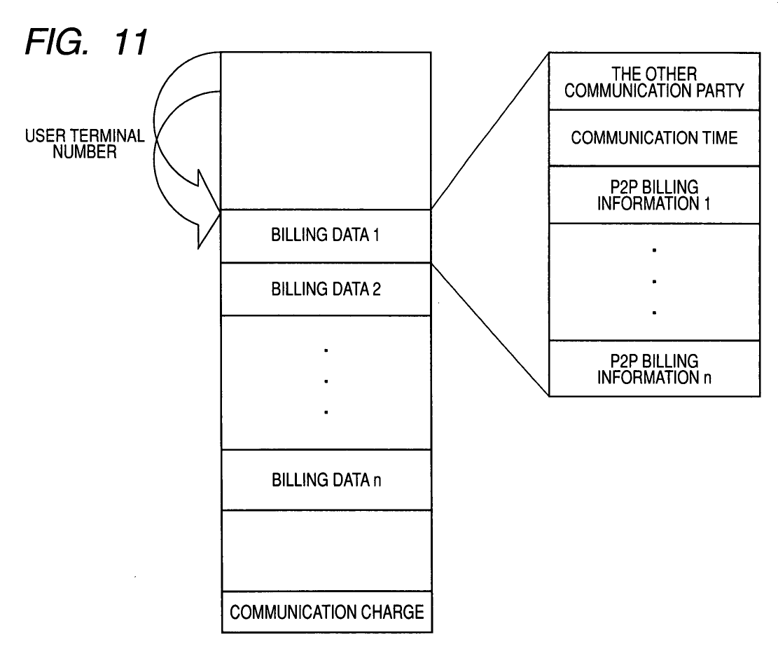

FIG. 11 shows an example of the billing data for a user terminal. The billing server 5 manages a user terminal number (telephone number) and billing data in connection. In the example shown in FIG. 11, information including billing data pieces 1 to n is stored for each communication parties. One billing data piece stores a communication party (telephone number), a communication time and information including P2P billing information pieces 1 to n. One P2P billing information piece is the result of the multiplication of the billing rate relating to the contents acquired by an arbitrary user terminal, which is stored in the main storage device, by the communication time. The P2P billing information pieces 1 to n are calculated and stored for each session. In the example shown in FIG. 11, the total of communication charges for each user terminal number is calculated and is stored along with the billing data. However, the communication charge may be calculated for each other communication party, and the billing information may be stored along with the P2P billing information relating to the contents acquisition.

Referring back to the sequence diagram in FIG. 4, in the user terminal 2, the agreement message transmitted from the call control server 4 is received by the agreement receiving section 12b4, and the agreement information described at the last line is read out and displayed on the liquid crystal display unit 24.

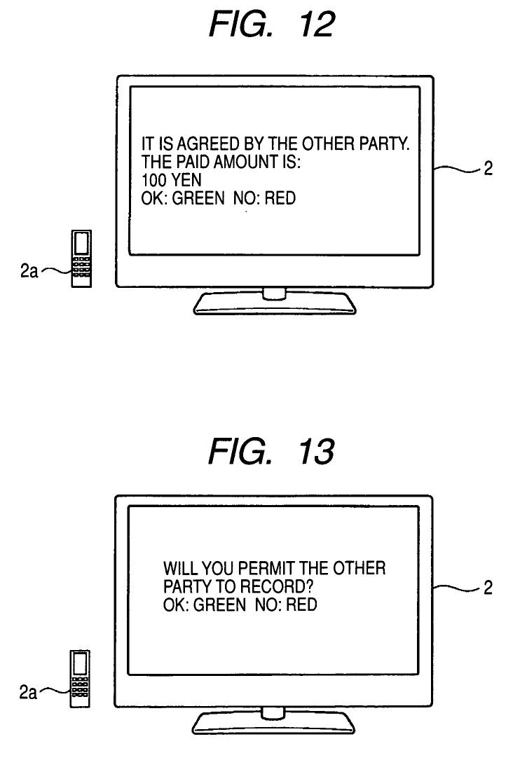

FIG. 12 shows an example of the agreement display screen. The screen of the user terminal 2 displays a message indicating that the billing rate notified by the user terminal 2 has been agreed by the user terminal 1. In this example, the fact that the billing server 5 is charged 100 yen is displayed. If the user of the user terminal 2 checks the paid amount and pushes the OK (green) button on the remote controller apparatus 2a, the screen display is changed to a recording permission screen.

FIG. 13 shows an example of the recording permission screen. The screen displays a message prompting the user of the user terminal 2 to finally determine whether the other party (which is the user terminal 1) is allowed to record or not. In order to agree, the OK (green) button on the remote controller apparatus 2a may be pushed. In order to disagree, the NO (red) button may be pushed.

Then, if the OK (green) button is pushed, the provision permitting section 12b5 of the user terminal 2 transmits a recording permission message to the call control server 4 (step S8). The call control server 4 further transmits the recording permission message to the user terminal 1 (step S9).

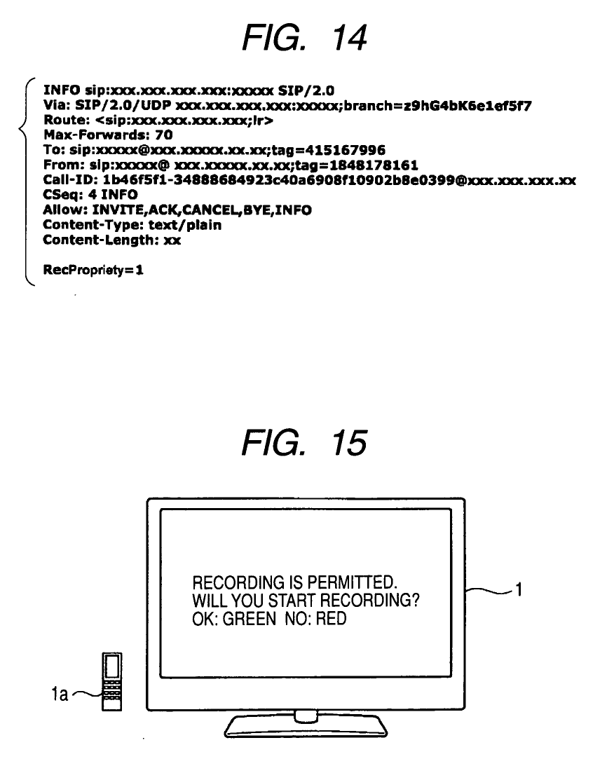

FIG. 14 shows an example of the recording permission message. The recording permission message describes an INFO method meaning information notification during a session at the start line of an SIP message. In the example shown in FIG. 14, “RecPropriety=1” is described on the last recording permission line. In this example, setting Flag 1 means the will of recording permission.

In the user terminal 1, if the contents acquiring section 12a5 receives the recording permission message, the fact that the recording is permitted is displayed on the liquid crystal display unit 24. Alternatively, an indicator lamp may be provided at a predetermined position of the user terminal 1, and the indicator lamp may be lighted.

FIG. 15 shows an example of the screen for notifying recording permission (or permission for contents acquisition). The screen of the user terminal 1 displays a message that notifies a user of the fact that the recording is permitted and prompts to instruct whether the recording is to be started or not. If the OK (green) button on the remote controller apparatus 2a is pushed, the recording of pay information is allowed.

If the agreement message is received from the user terminal 1 and it is determined that the user has instructed to start the recording, the provision permitting section 12b5 of the user terminal 2 provides the pay information (contents) to the user terminal 1 (step S10). In this example, the fortune teller on the user terminal 2 side may move a camera of the television telephone toward his or her face, a crystal ball or cards, for example, and communicates with the user on the user terminal 1 side.

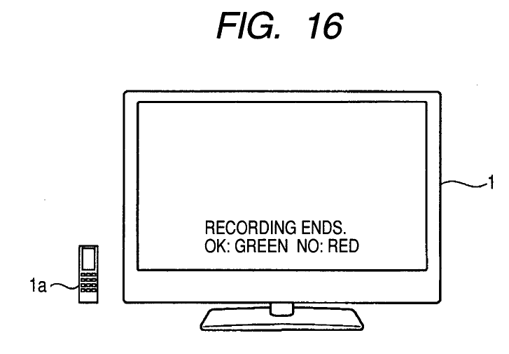

The contents acquiring section 12a5 of the user terminal 1 implements the recording of the pay information (contents) transmitted from the user terminal 2 and stores the requested contents to the external storage device 15. In the user terminal 1, if the recording of the pay information ends, a recording end screen as shown in FIG. 16 is displayed. In order to finish the recording, the OK (green) button on the remote controller apparatus 1a may be pushed. If not, the NO (red) button may be pushed.

In order to exit the session after the recording of the contents ends, the processing in steps S41 to S43 shown in FIG. 5 may be performed, whereby the session is disconnected. If the pay information provision is further requested by the user of the user terminal 1, the series of steps of the processing is repeated.

In this way, the provision of and payment (banking) for pay information are performed from the course of conversation. In the case of fortune telling in this example, pay information that varies in real time can be recognized through communication such as what the fortune telling about (such as love) and what kind of method (such as star gazing and palm reading) is used for the fortune telling. This is not limited to fortune-telling, but various requests can be met such as recognition and change of pay information on a television telephone for a video, a music, a computer program, data or the like.

A packet (which is a video packet or an audio packet) is directly exchanged between actual communication terminals without through the call control server 4. In other words, the request for pay information provision (step S2) and the provision of pay information (step S10) are not based on an SIP message but are based on an audio packet or a video packet itself. Therefore, the communication is performed directly between terminals.

As described above, according to the aforesaid embodiment, in a case where pay information (or contents) is provided to the other terminal between users during real time communication between users with telephones over a network, such as an NGN network, allowing acquisition of pay information through the interface of telephone numbers, the billing rate information, agreement information, payment information (P2P billing notification) and recording permission information are notified to the other terminal or billing server through an IP communication message. Thus, in real time, the billing rate can be set, and the pay information can be provided and/or recorded. Through the communication between users, pay information (or contents) can be acquired in association with the setting and agreement of the billing rate.

Therefore, during real time communication as in a telephone service, pay information can be acquired dynamically and flexibly. As a result, even people who may not obtain information from a network because of unfamiliarity with operations on a terminal apparatus such as a PC in the past can easily acquire pay information on the spot, which can largely contribute to the improvement of the convenience for users.

According to the aforesaid embodiment, the banking processing based on the billing data for a user terminal, which is stored in the billing server, can be implemented by using an existing method. For example, the fee based on the billing data relating to contents acquisition may be charged from a user's account opened in a bank together with a normal communication charge. Alternatively, separately from a normal communication charge, the fee based on the billing data relating to contents acquisition may be charged from a different account or may be paid by online banking or through the bank.

The invention is not limited to the embodiments above, and various modifications and changes can be made thereto without departing from the spirit and scope of the invention.

What is claimed is:

1. A contents billing system that bills for contents provided between a first terminal and a second terminal establishing a session for calling and data communication through a connection management server, wherein:
billing rate information for contents requested to provide by a first user of the first terminal by calling is transmitted to the first terminal through the connection management server based on an instruction by a second user of the second terminal;
the first terminal receives billing rate information on the selected contents and then transmits agreement information according to an agreement operation on the billing rate by the first user to the second terminal through the connection management server;
the connection management server notifies a billing server of the billing rate according to the agreement information and transmits the agreement information to the second terminal;
the second terminal receives the agreement information on the billing rate information, then transmits recording permission information for the contents to the first terminal through the connection management server and transmits the contents to the first terminal; and
the first terminal receives the recording permission information for the contents and then acquires the selected contents from the second terminal.

2. A contents acquiring apparatus comprising:
a communication unit for performing calling and data communication with the other terminal;
a provision request notifying section that transmits provision request information for contents to the other terminal through calling with the other terminal;
a billing rate receiving section that receives billing rate information for the selected contents from the other terminal;
an agreement notifying section that transmits agreement information to the other terminal according to an agreement operation for the billing rate by the user; and
a contents acquiring section that receives recording permission information for the contents from the other terminal having received the agreement information and acquires the selected contents from the other terminal.

3. The contents acquiring apparatus according to claim 2, wherein the agreement information transmitted from the agreement notifying section is transmitted to the other terminal through a connection management server, and the connection management server transmits the agreement information to the other terminal when the billing rate is notified to a billing server upon receipt of the agreement information.

4. The contents acquiring apparatus according to claim 3, further comprising:
an image signal generating section that generates an image signal of a screen to be displayed on a display unit,
wherein the image signal generating section generates image signals of a screen for displaying the billing rate to be agreed and a screen displaying recording permission information for the contents.

5. A contents acquiring method comprising the steps of:
establishing a session for calling and data communication with the other terminal;
transmitting provision request information for contents to the other terminal through calling with the other terminal;
receiving billing rate information for the selected contents from the other terminal;
transmitting agreement information to the other terminal according to an agreement operation for the billing rate by the user; and
receiving recording permission information for the contents from the other terminal having received the agreement information and acquiring the selected contents from the other terminal.

6. A program causing a computer to perform a contents acquiring method comprising the steps of:
establishing a session for calling and data communication with the other terminal;
transmitting provision request information for contents to the other terminal through calling with the other terminal;
receiving billing rate information for the selected contents from the other terminal;
transmitting agreement information to the other terminal according to an agreement operation for the billing rate by the user; and
receiving recording permission information for the contents from the other terminal having received the agreement information and acquiring the selected contents from the other terminal.

7. A contents providing apparatus comprising:
a communication unit for performing calling and data communication with the other terminal;
a provision request receiving section that receives provision request information for contents to the other terminal through calling with the other terminal;
a billing rate notifying section that transmits billing rate information for contents for which the provision request is received based on an instruction by a user;
an agreement receiving section that receives agreement information for the billing rate information from the other terminal; and
a provision permitting section that transmits recording permission information for the contents and transmits the contents to the other terminal after receiving the agreement information.

8. The contents providing apparatus according to claim 7, wherein the billing rate notifying section notifies a billing rate instructed by the user for the contents.

9. The contents providing apparatus according to claim 8, further comprising:
an image signal generating section that generates an image signal of a screen to be displayed on a display unit, wherein the image signal generating section generates image signals of a screen for displaying the billing rate for the contents and a screen displaying the agreement information on the billing rate for the contents.

10. A contents providing method comprising the steps of:
establishing a session for calling and data communication with the other terminal;
receiving provision request information for contents from the other terminal through calling with the other terminal;
transmitting billing rate information for contents for which the provision request is received based on an instruction by a user;
receiving agreement information for the billing rate information from the other terminal; and
transmitting recording permission information for the contents to the other terminal and transmitting the contents to the other terminal after receiving the agreement information.

11. A program causing a computer to perform a contents providing method comprising the steps of:
establishing a session for calling and data communication with the other terminal;
receiving provision request information for contents from the other terminal through calling with the other terminal;
transmitting billing rate information for contents for which the provision request is received based on an instruction by a user;
receiving agreement information for the billing rate information from the other terminal; and
transmitting recording permission information for the contents to the other terminal and transmitting the contents to the other terminal after receiving the agreement information.
